(19) United States
(12) Patent Application Publication
(10) Pub. No.: US 2025/0073688 A1
(43) Pub. Date: Mar. 6, 2025

(54) GRAPHITIC CARBON NITRIDE-GRAFTED HYBRID COVALENT ORGANIC FRAMEWORK FOR PHOTOCATALYTIC HYDROGEN EVOLUTION FROM VARIOUS WATER SOURCES

(71) Applicant: Qatar Foundation for Education, Science and Community Development, Doha (QA)

(72) Inventors: Santhosh Babu Sukumaran, Doha (QA); Kiran Asokan, Doha (QA); Bhagyasree T. M., Doha (QA); Konstantinos E. Kakosimos, Doha (QA); Lina Rueda, Doha (QA); Mohamed Al-Hashimi, Doha (QA); Dhabia Al-Mohannadi, Doha (QA)

(21) Appl. No.: 18/817,730

(22) Filed: Aug. 28, 2024

Related U.S. Application Data
(60) Provisional application No. 63/534,923, filed on Aug. 28, 2023.

(51) Int. Cl. B01J 31/16; B01J 35/39; B01J 37/04; B01J 37/34

(52) U.S. Cl. CPC B01J 31/1625; B01J 35/39; B01J 37/04; B01J 37/344

(57) ABSTRACT

A method of manufacturing a gC₃N₄-grafte hybrid covalent organic framework is provided. The method includes synthesizing 1,3,5-triformyl phloroglucinol (Tp), p-phenylene diamine (ppd), and gC₃N₄ to form Tp-ppd-gC₃N₄₋ₓ covalent organic frameworks (COFs), where x represents a weight % (wt %) of gC₃N₄ with respect to a total weight of aldehyde and amine.

### CROSS-REFERENCE TO RELATED APPLICATION

The present application claims priority to U.S. Provisional Application No. 63/534,923 filed Aug. 28, 2023, and entitled “GRAPHITIC CARBON NITRIDE-GRAFTED HYBRID COVALENT ORGANIC FRAMEWORK FOR PHOTOCATALYTIC HYDROGEN EVOLUTION FROM VARIOUS WATER SOURCES,” the disclosure of which is incorporated by reference herein in its entirety.

### BACKGROUND

The utilization of renewable sources for the production of energy is a crucial factor in sustainable development. Hydrogen (H₂), the most abundant element in the universe, is a clean fuel that can be used instead of other fossil fuels. Availability, zero-emission, environment friendliness, efficiency, and renewability are the advantages of H₂ over other fuel sources. Besides these, H₂ has some limitations regarding storage and flammability, and more importantly, H₂ is expensive. Conventional production of H₂ is from natural gases, naphtha and heavy oil, coal, electrolysis, etc, and H₂ is industrially produced by using the Bosch process. Interestingly, 71% of the earth is covered with water which is one of the best sources of H₂. Extracting H₂ from water using electrolysis has been challenging since it requires a lot of energy to separate H₂ and O₂.

### SUMMARY

The present disclosure generally relates to a gC₃N₄-grafted hybrid covalent organic framework for photocatalytic hydrogen evolution from various water sources.

In light of the present disclosure, and without limiting the scope of the disclosure in any way, in an aspect of the present disclosure, which may be combined with any other aspect listed herein unless specified otherwise, a method for manufacturing a gC₃N₄-grafted hybrid covalent organic framework for photocatalytic hydrogen evolution is provided. The method may include synthesizing 1,3,5-triformyl phloroglucinol (Tp), p-phenylene diamine (ppd), and gC₃N₄ to form Tp-ppd-gC₃N₄₋ₓ covalent organic framework (TPG COF), where x represents a weight % (wt %) of gC₃N₄ with respect to a total weight of aldehyde and amine.

In an aspect of the present disclosure, which may be combined with any other aspect listed herein unless specified otherwise, x is one of 1, 5, 10, 25, 50, 75, and 100 wt %.

In an aspect of the present disclosure, which may be combined with any other aspect listed herein unless specified otherwise, x is one of 50, 75, and 100 wt %.

In an aspect of the present disclosure, which may be combined with any other aspect listed herein unless specified otherwise, the synthesizing comprises mechanochemical synthesis.

In light of the present disclosure, and without limiting the scope of the disclosure in any way, in an aspect of the present disclosure, which may be combined with any other aspect listed herein unless specified otherwise, a hybrid covalent organic framework for photocatalytic hydrogen evolution is provided. The hybrid covalent organic framework comprises Tp-ppd-gC₃N₄₋ₓ covalent organic framework (TPG COF), where Tp represents 1,3,5-triformyl phloroglucinol, ppd represents p-phenylene diamine, and x represents a weight % (wt %) of gC₃N₄ with respect to a total weight of aldehyde and amine.

In an aspect of the present disclosure, which may be combined with any other aspect listed herein unless specified otherwise, x is one of 1, 5, 10, 25, 50, 75, and 100 wt %.

In an aspect of the present disclosure, which may be combined with any other aspect listed herein unless specified otherwise, x is one of 50, 75, and 100 wt %.

In light of the present disclosure, and without limiting the scope of the disclosure in any way, in an aspect of the present disclosure, which may be combined with any other aspect listed herein unless specified otherwise, a method for generating H₂ from H₂O using hybrid covalent organic framework as photocatalyst is provided. The method includes dispersing a Tp-ppd-gC₃N₄₋ₓ covalent organic framework (TPG COF) in H₂O to form a TPG COF solution, where x represents a weight % (wt %) of gC₃N₄ with respect to a total weight of aldehyde and amine; adding a sacrificial electron donor (SED) to the TPG COF solution to form a first mixture; adding a co-catalyst to the first mixture to form a second mixture; emitting a light source to the second mixture.

In an aspect of the present disclosure, which may be combined with any other aspect listed herein unless specified otherwise, the SED comprises ascorbic acid.

In an aspect of the present disclosure, which may be combined with any other aspect listed herein unless specified otherwise, the co-catalyst comprises PVP-Pt NP.

In an aspect of the present disclosure, which may be combined with any other aspect listed herein unless specified otherwise, the method further comprises subsequent to adding the SED to the TPG COF solution, sonicating the first mixture for a first amount of time; and subsequent to adding the co-catalyst, tight-sealing the second mixture and purging the second mixture with an inert gas.

In an aspect of the present disclosure, which may be combined with any other aspect listed herein unless specified otherwise, x is one of 1, 5, 10, 25, 50, 75, and 100 wt %.

Additional features and advantages of the disclosed systems and methods are described in, and will be apparent from, the following Detailed Description and the Figures.

### BRIEF DESCRIPTION OF THE FIGURES

FIG. 1 illustrates a synthesis scheme of Tp-ppd-gC₃N₄ (TPG) hybrid COF according to an example of the present disclosure.

FIG. 2 illustrates a bulk-scale synthesis of the hybrid COF catalysts using a planetary mixer according to an example of the present disclosure.

FIG. 3 is a graph showing ¹³C CP-MAS spectrum of TPG hybrid COF with different weight percentages of gC₃N₄.

FIG. 4 is a graph showing FT-IR spectrum of different weight percentages incorporated TPG hybrid COFs.

FIG. 5 illustrates SEM (a,b) and HR-TEM (c,d) images of TPG-50% showing sheet-like morphology.

FIG. 6 illustrates a) STEM images of TPG-50 with elemental mapping, b) overlay, c) C K, d) N K, e) 0 K.

FIG. 7. is a graph showing the HER performance of TPG-50 by varying amounts of ascorbic acid and co-catalyst amount.

FIG. 8. is a graph showing the HER performance of TPG-75 (conditions:5 mg C, 200 mg AA, 100 μL PVP-Pt Np, 20 mL H2O).

FIG. 9. is a graph comparing the HER performance of TPG catalysts (conditions:5 mg C, 200 mg AA, 100 μL PVP-Pt Np, 20 mL H2O).

FIG. 10. is a graph showing the cyclic HER performance of TPG-75 (conditions:5 mg C, 200 mg AA, 100 μL PVP-Pt Np, 20 mL H2O).

FIG. 11. is a graph comparing the HER of TPG-75 with the different water sources such as deionized water, and GTL HPS effluent water, and brine back to sea water supplied by QSRTC.

### DETAILED DESCRIPTION OF EXAMPLE EMBODIMENTS

The present disclosure generally relates to a gC₃N₄-grafted hybrid covalent organic framework for photocatalytic hydrogen evolution from various water sources.

As discussed above, 71% of the earth is covered with water which is one of the best sources of H₂. Extracting H₂ from water using electrolysis has been challenging since it requires a lot of energy to separate H₂ and O₂. Solar H2 from water using heterogenous catalysts offers a clean energy source. The advent of photocatalysis has paved a new way for H₂ generation from water.

Many inorganic semiconductors like TiO₂, CdS, ZnO₂, and ZnGa₂O₄ have been explored as photocatalysts for water splitting. Nevertheless, limited visible light harvesting, polluting metals, low adsorption capacity, cost, and rapid charge recombination are drawbacks of the inorganic catalysts.

In recent years, organic photocatalysis has outperformed some prominent inorganic catalysts in H₂ generation due to its attractive optical properties and facile, scalable synthetic protocols. Graphitic carbon nitride (gC₃N₄), conjugated polymers, and porous materials such as metal-organic frameworks (MOFs), covalent triazine frameworks (CTFs), and covalent organic frameworks (COFs) are now being extensively tested for H₂ evolution from water.

COFs may be crystalline 2D or 3D materials of lighter elements, including B, C, N, O, H formed via covalent bonds exhibiting long-range order and periodic arrangement. Intrinsic porosity and high crystallinity of COFs may make them suitable for different applications such as gas storage, energy storage, targeted drug delivery, molecular sorption and separation, molecular sensing, catalysis, optoelectronics, piezoelectrics, and so on. Modifications of COFs can be achieved by changing linkers, and hence properties can be tuned accordingly. The first of the kind was reported by Yaghi and co-workers back in 2005 by condensing benzene boronic acid (BDBA) alone and in the presence of hexahydroxytriphenylene (HHTP), obtaining a boroxine COF (COF-1) and a boronate ester COF (COF-5), respectively. Over time, several COFs were reported with new synthetic methodologies and linkages, such as imine, hydrazone, azine, amide, imide, C═C, C—C, 1,4-dioxin, triazine, etc. Facile preparation, functionality, modularity, stability, and scalability have made these frameworks ideal for different applications.

Organic catalysts reported so far for producing H₂ from water are only on a small lab scale. Hence scalability is a challenging problem. And also, the reported H₂ production rate is relatively low. Besides, the organic catalysts are reported to perform (only) in deionized (pure) water.

Aspects of the present disclosure may solve the problem of scalability of catalyst preparation. The hybrid catalyst according to the present disclosure can be easily synthesized on a bulk scale with commercially available starting materials. Also, the rate with which the catalyst performs is higher than most reported ones regarding photocatalytic production of H₂ from industrial wastewater. The present disclosure may provide a scalable synthesis of organic photocatalysts exhibiting high H₂ production even from industrial wastewater.

In some examples, a hybrid photocatalyst according to the present disclosure can be readily adopted for the production of H₂ because the starting materials for synthesis are commercially available. The process adopted for synthesis may be a mechanochemical method that can be performed at an industrial scale. Production of H₂ can be performed in any optically accessible vessel under direct sunlight or artificial light. The sacrificial electron donor used for the demonstration is ascorbic acid, which is commercially available, while other SEDs can be employed as well. The co-catalyst, PVP-coated Pt nanoparticles, can be easily synthesized on a bulk scale. Finally, multiple water sources can be used e.g. distilled and industrial wastewater.

In some examples, the present disclosure may be related to the synthesis of P-ketoenamine-linked hybrid COFs and application thereof in photocatalytic H₂ evolution reaction (HER) according to an embodiment. A hybrid COF Tp-ppd-gC₃N₄ may be prepared through mechanochemical synthesis using 1,3,5-triformyl phloroglucinol (Tp), p-phenylene diamine (ppd), and gC₃N₄. The quantity of gC₃N₄ may be varied to get a different Tp-ppd-gC₃N₄₋ₓ COFs (x=1, 5, 10, 25, 50, 75, 100% of gC₃N₄ with respect to the total amount of aldehyde and amine). The synthesized COFs may be characterized by solid-state ¹³C NMR, IR, PXRD, BET, SEM, and TEM to confirm the structure and morphology.

In some examples, a method for manufacturing a gC₃N₄-grafted hybrid covalent organic framework for photocatalytic hydrogen evolution is provided. The method may include synthesizing 1,3,5-triformyl phloroglucinol (Tp), p-phenylene diamine (ppd), and gC₃N₄ to form Tp-ppd-gC₃N₄₋ₓ covalent organic framework (TPG COF).

Here, x may represent a weight % (wt %) of gC₃N₄ with respect to a total weight of aldehyde and amine. In some examples, x may be one of 1, 5, 10, 25, 50, 75, and 100 wt %, preferably one of one of 50, 75, and 100 wt %.

In some examples, a hybrid covalent organic framework for photocatalytic hydrogen evolution is provided. The hybrid covalent organic framework may include Tp-ppd-gC₃N₄₋ₓ covalent organic framework (TPG COF), where Tp may represent 1,3,5-triformyl phloroglucinol, ppd may represent p-phenylene diamine, and x may represent a weight % (wt %) of gC₃N₄ with respect to a total weight of aldehyde and amine. In some examples, x may be one of 1, 5, 10, 25, 50, 75, and 100 wt %, preferably one of one of 50, 75, and 100 wt %.

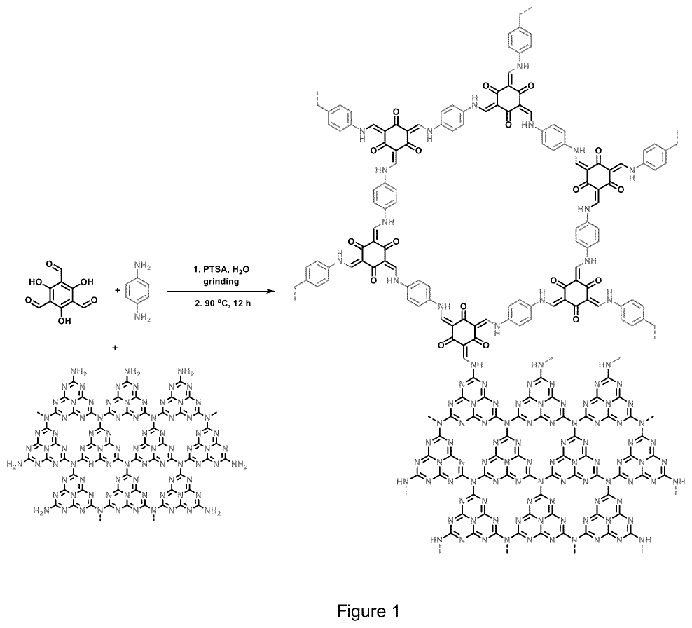

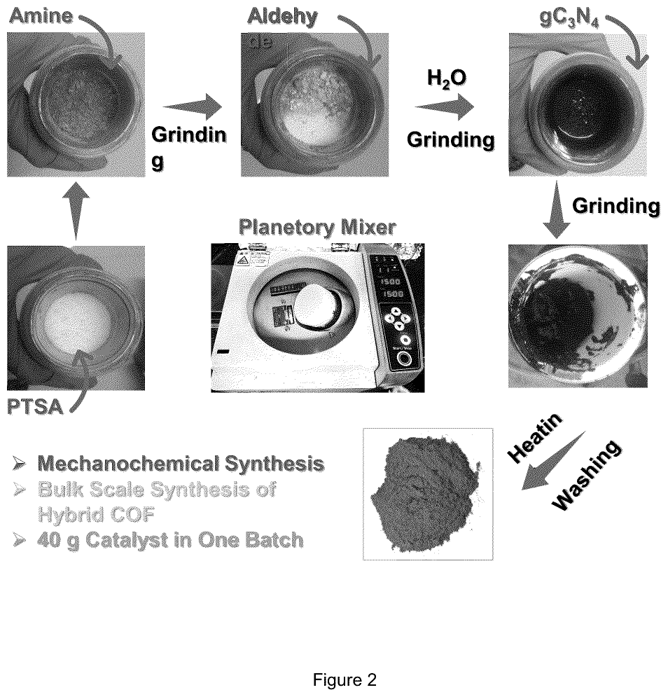

FIG. 1 illustrates a synthesis scheme of Tp-ppd-gC₃N₄ (TPG) hybrid COF according to an example of the present disclosure. FIG. 2 illustrates a bulk-scale synthesis of the hybrid COF catalysts using a planetary mixer according to an example of the present disclosure.

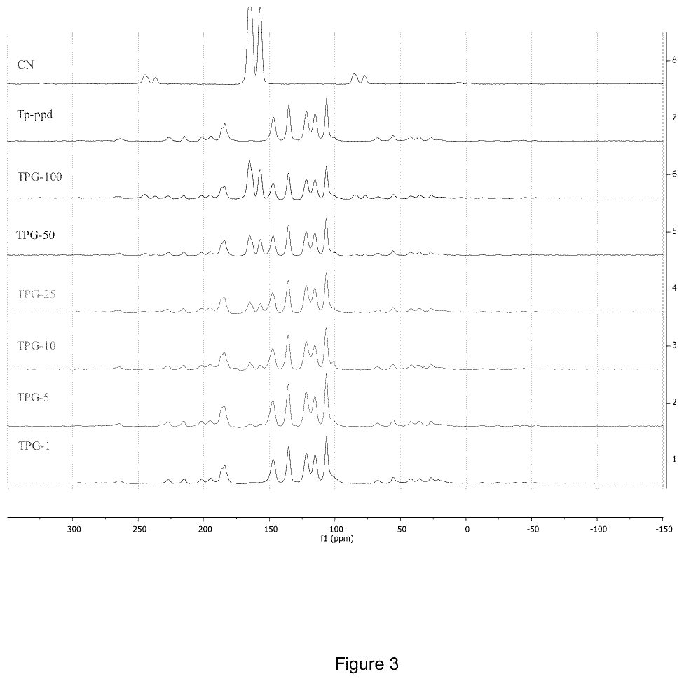

FIG. 3 is a graph showing ¹³C CP-MAS spectrum of TPG hybrid COF with different weight percentages of gC₃N₄.

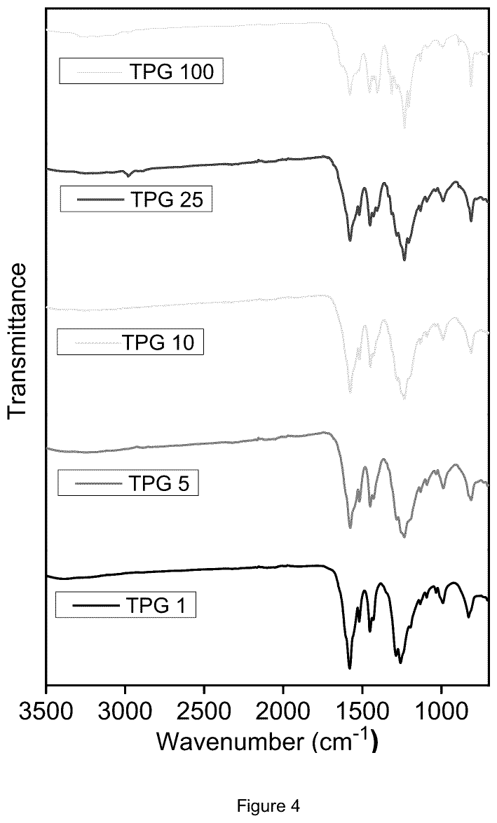

FIG. 4 is a graph showing FT-IR spectrum of different weight percentages incorporated TPG hybrid COFs.

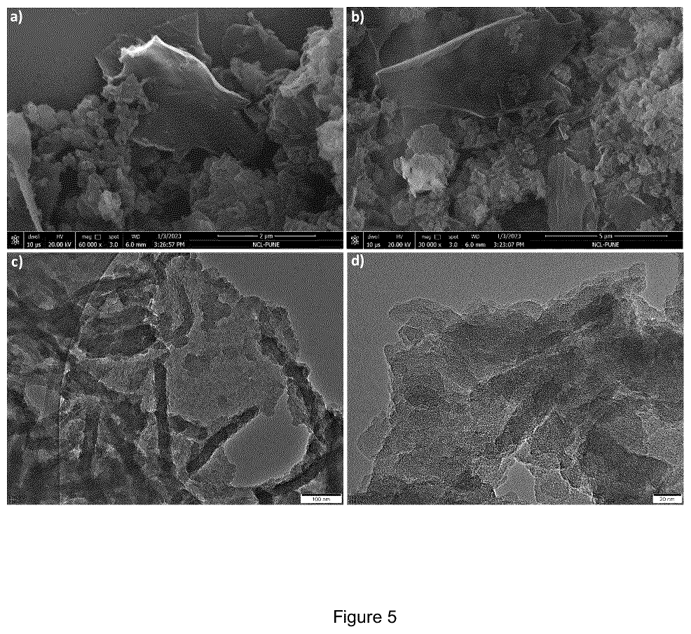

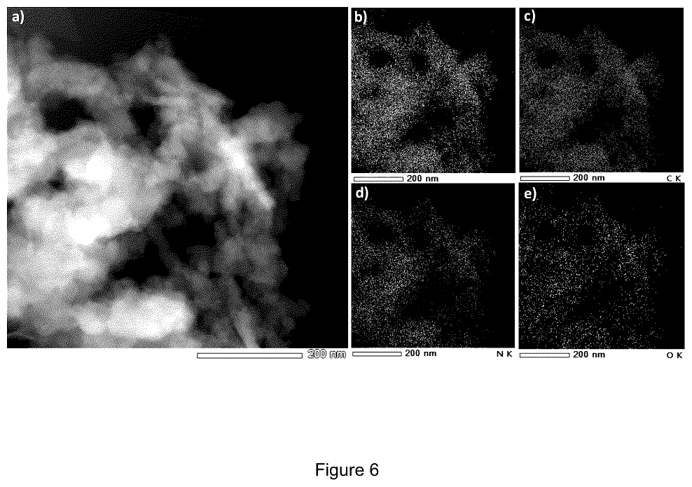

FIG. 5 illustrates SEM (a,b) and HR-TEM (c,d) images of TPG-50% showing sheet-like morphology. FIG. 6 illustrates a) STEM images of TPG-50 with elemental mapping, b) overlay, c) C K, d) N K, e) O K.

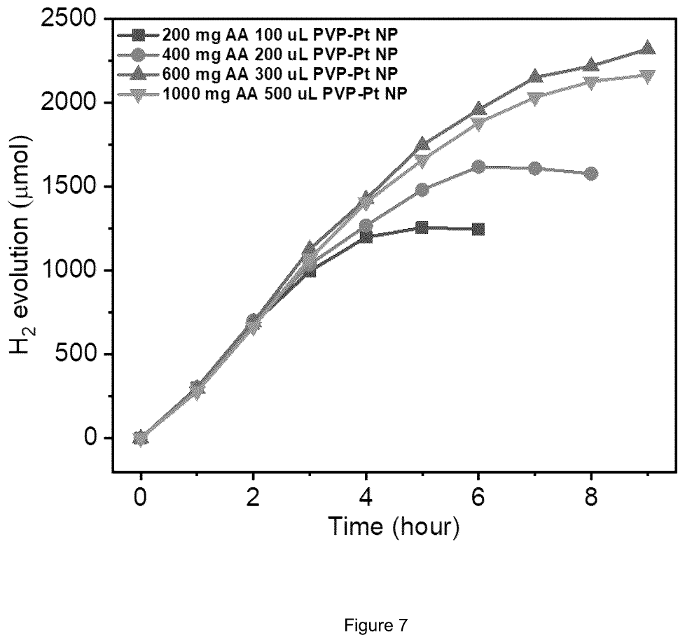

FIG. 7. is a graph showing the HER performance of TPG-50 by varying amounts of ascorbic acid and co-catalyst amount. As shown in FIG. 7, TPG-50 showed the best HER performance over time when the amounts of ascorbic acid (AA) and PVP-Pt NP were 600 mg and 300 μL, respectively.

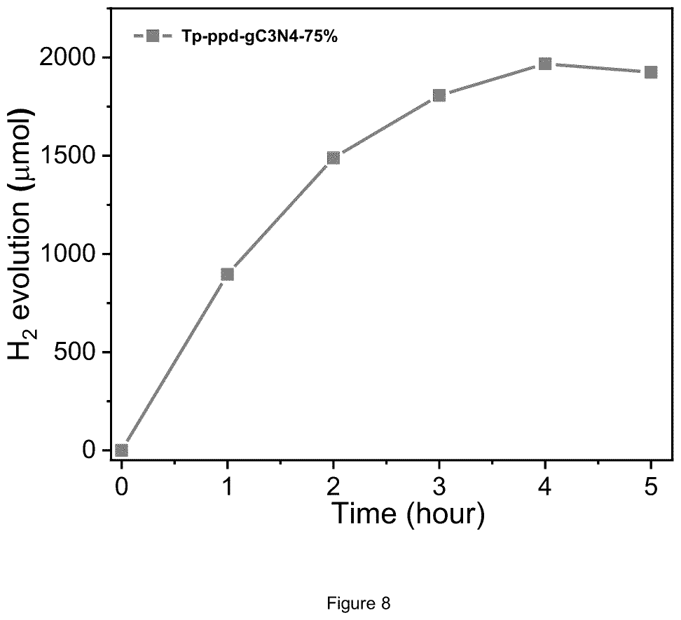

FIG. 8. is a graph showing the HER performance of TPG-75 (conditions:5 mg C, 200 mg AA, 100 μL PVP-Pt Np, 20 mL H2O). As shown in FIG. 7, TPG-70 showed the best HER performance around 4 to 5 hours after TPG-75 is dispersed in H₂O with AA and PVP-Pt NP.

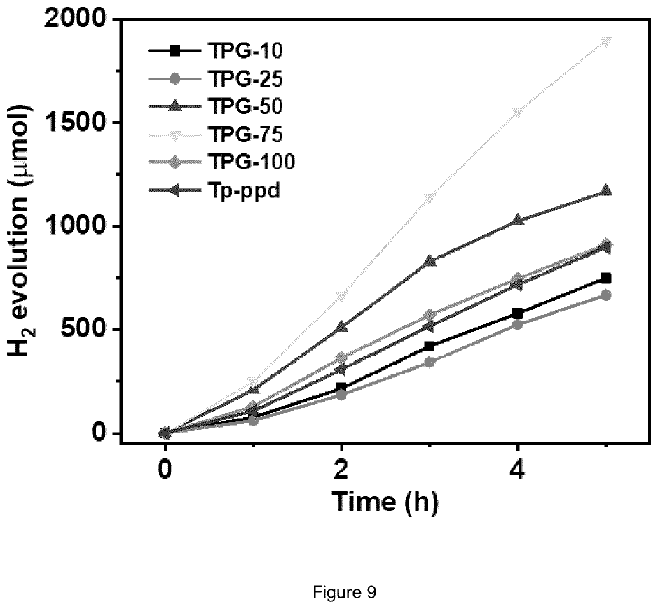

FIG. 9. is a graph comparing the HER performance of TPG catalysts (conditions:5 mg C, 200 mg AA, 100 μL PVP-Pt Np, 20 mL H2O). As shown in FIG. 9, among TPG-10, TPG-25, TPG-50, TPG-75, TPG-100, and Tp-ppd, TPG-75 showed the best HER performance over time.

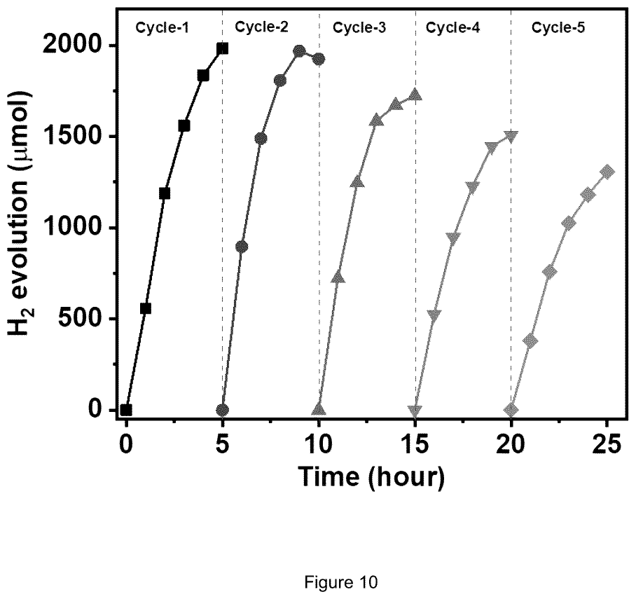

FIG. 10. is a graph showing the cyclic HER performance of TPG-75 (conditions:5 mg C, 200 mg AA, 100 μL PVP-Pt Np, 20 mL H2O).

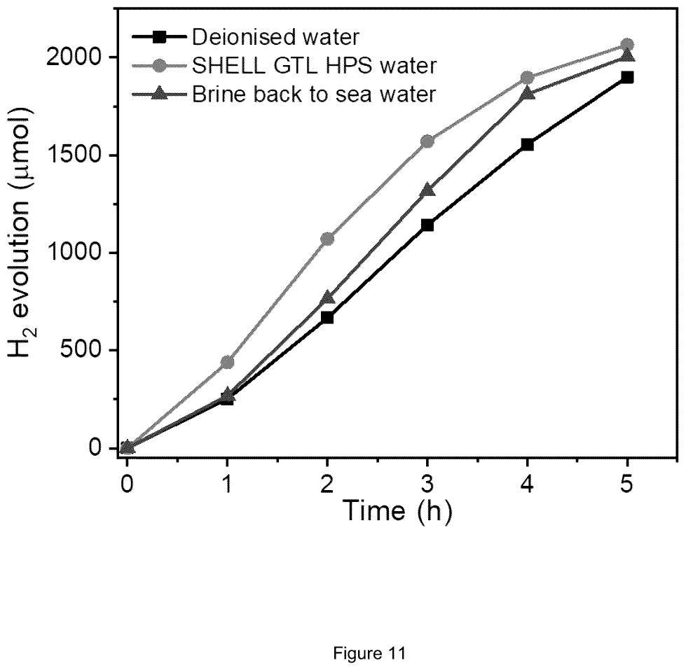

FIG. 11. is a graph comparing the HER of TPG-75 with the different water sources such as deionized water, and GTL HPS effluent water, and brine back to sea water supplied by QSRTC. As shown in FIG. 11, the hybrid COF according to the present disclosure shows great HER performance not only with deionized water, but also with other types of water, such as sea water or industrial wastewater.

In some examples, a method for generating H₂ from H₂O using hybrid covalent organic framework as photocatalyst is provided. The method includes dispersing a Tp-ppd-gC₃N₄₋ₓ covalent organic framework (TPG COF) in H₂O to form a TPG COF solution, where x represents a weight % (wt %) of gC₃N₄ with respect to a total weight of aldehyde and amine. In some examples, x is one of 1, 5, 10, 25, 50, 75, and 100 wt %.

Then, the method may also include adding a sacrificial electron donor (SED) to the TPG COF solution to form a first mixture. In some examples, the SED may include ascorbic acid.

The method may further include adding a co-catalyst to the first mixture to form a second mixture. In some examples, the co-catalyst may include PVP-Pt NP.

In some examples, the method may include, subsequent to adding the co-catalyst, tight-sealing the second mixture and purging the second mixture with an inert gas, for example, for a second amount of time.

In some examples, the method may include emitting a light source to the second mixture, for example, to generate H₂. As shown above, the present disclosure may use the hybrid COF materials as a catalyst for photocatalytic HER from water. For example, photocatalytic HER from water has been performed by varying the amounts of sacrificial electron donor (SED) and Co-catalyst. The reactions were successful in yielding H₂ in 179 mmol g⁻¹ h⁻¹ (under UV-Vis-IR light irradiation} and 77 mmol g⁻¹ h⁻¹ (under Visible light irradiation} with ascorbic acid (AA) as SED and Polyvinyl Pyrrolidone coated Pt nanoparticle (PVP-Pt NP) as Co-catalyst. The present disclosure may achieve the bulk-scale synthesis (40 g batch) of a stable and durable hybrid COF catalyst suitable for commercial H₂ production. The hybrid catalyst may exhibit superior H₂ production from industrial wastewater also.

### Examples

Some example hybrid COF materials were prepared. Experiments were conducted by dispersing 5 mg of catalyst in H₂O (20 ml) in a quartz reactor of 50 ml capacity, followed by adding 200 mg of Ascorbic Acid (SED). The reactor, along with the mixture, is sonicated for 30 minutes. To this 100 μL of PVP-Pt NP (Co-Catalyst) solution is added and air-tight sealed. It is then purged with Ar gas for 30 min and kept for visible light irradiation using a solar simulator. The gas evolved was quantified using a Gas Chromatography (GC) instrument with a Thermal Conductivity detector. Various conditions were tested by changing SED and Co-Catalyst. Later, the hybrid COF materials were used for screening the performance of different derivatives of hybrid COF photocatalyst.

The results showed that hybrid COF Tp-ppd-gC₃N₄-75 (with 75% g C₃N₄) outperformed other hybrid COF samples exhibiting an average H₂ evolution of 179 mmol g⁻¹ h⁻¹ (under UV-Vis-lR light irradiation, FIG. 7) and 77 mmol g⁻¹ h⁻¹ (under Visible light irradiation). The catalyst also outperforms many reported COFs regarding solar-to-hydrogen (STH) conversion, exhibiting more than 2.8%.

The present disclosure can be used to synthesize a hybrid catalyst on a bulk scale for photocatalytic generation of H₂ from water. It may be also effective in producing H₂ from non-potable water sources also. The starting materials may be available commercially, which may make bulk-scale catalyst synthesis feasible.

In some examples, new hybrid material can be synthesized with improved efficiency by changing the COF linkers/building blocks. New synthetic methodologies can be adopted to reduce the cost of the catalyst. Apart from photocatalysis, hybrid photoelectrocatalysis may increase the rate and efficiency of the catalyst with the help of an external power supply. This, in turn, can increase H₂ production.

As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

Reference throughout the specification to “various aspects,” “some aspects,” “some examples,” “other examples,” “some cases,” or “one aspect” means that a particular feature, structure, or characteristic described in connection with the aspect is included in at least one example. Thus, appearances of the phrases “in various aspects,” “in some aspects,” “certain embodiments,” “some examples,” “other examples,” “certain other embodiments,” “some cases,” or “in one aspect” in places throughout the specification are not necessarily all referring to the same aspect. Furthermore, the particular features, structures, or characteristics illustrated or described in connection with one example may be combined, in whole or in part, with features, structures, or characteristics of one or more other aspects without limitation.

It is to be understood that at least some of the figures and descriptions herein have been simplified to illustrate elements that are relevant for a clear understanding of the disclosure, while eliminating, for purposes of clarity, other elements. Those of ordinary skill in the art will recognize, however, that these and other elements may be desirable. However, because such elements are well known in the art, and because they do not facilitate a better understanding of the disclosure, a discussion of such elements is not provided herein.

The terminology used herein is intended to describe particular embodiments only and is not intended to be limiting of the present disclosure. As used herein, the singular forms “a,” “an,” and “the” are intended to include the plural forms as well, unless otherwise indicated. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “at least one of X or Y” or “at least one of X and Y” should be interpreted as X, or Y, or X and Y.

It should be understood that various changes and modifications to the examples described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method comprising:
synthesizing 1,3,5-triformyl phloroglucinol (Tp), p-phenylene diamine (ppd), and gC₃N₄ to form Tp-ppd-gC₃N₄₋ₓ covalent organic framework (TPG COF),
wherein x represents a weight % (wt %) of gC₃N₄ with respect to a total weight of aldehyde and amine.

2. The method of claim 1, wherein x is one of 1, 5, 10, 25, 50, 75, and 100 wt %.

3. The method of claim 2, wherein x is one of 50, 75, and 100 wt %.

4. The method of claim 1, wherein the synthesizing comprises mechanochemical synthesis.

5. A hybrid covalent organic framework (COF) comprising:
Tp-ppd-gC₃N₄₋ₓ covalent organic framework (TPG COF),
wherein Tp represents 1,3,5-triformyl phloroglucinol,
wherein ppd represents p-phenylene diamine,
wherein x represents a weight % (wt %) of gC₃N₄ with respect to a total weight of aldehyde and amine.

6. The hybrid COF of claim 5, wherein x is one of 1, 5, 10, 25, 50, 75, and 100 wt %.

7. The hybrid COF of claim 6, wherein x is one of 50, 75, and 100 wt %.

8. A method comprising:
dispersing a Tp-ppd-gC₃N₄₋ₓ covalent organic framework (TPG COF) in H₂O to form a TPG COF solution, wherein x represents a weight % (wt %) of gC₃N₄ with respect to a total weight of aldehyde and amine;
adding a sacrificial electron donor (SED) to the TPG COF solution to form a first mixture;
adding a co-catalyst to the first mixture to form a second mixture;
emitting a light source to the second mixture.

9. The method of claim 8, wherein the SED comprises ascorbic acid.

10. The method of claim 8, wherein the co-catalyst comprises PVP-Pt NP.

11. The method of claim 8, further comprising:
subsequent to adding the SED to the TPG COF solution, sonicating the first mixture for a first amount of time; and
subsequent to adding the co-catalyst, tight-sealing the second mixture and purging the second mixture with an inert gas.

12. The method of claim 8, wherein x is one of 1, 5, 10, 25, 50, 75, and 100 wt %.
